(19) United States
(12) Patent Application Publication
(10) Pub. No.: US 2009/0291251 A1
(43) Pub. Date: Nov. 26, 2009

(54) NET-LIKE MATERIAL HAVING HEAT SHIELDING AND LIGHT TRANSMITTING PROPERTIES

(76) Inventors: Tokuhito Suzuki, Tomisato (JP); Fujio Itoh, Yokohama-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/813,448

(22) PCT Filed: Jan. 6, 2006
(86) PCT No.: PCT/JP2006/300084

§ 371 Date: Jul. 6, 2007

(30) Foreign Application Priority Data
Jan. 7, 2005 (JP) 2005-002551

(51) Int. Cl. B32B 5/12; D03D 9/00

(52) U.S. Cl. 428/107; 442/1

(57) ABSTRACT

A net-like material having an excellent heat shielding property while capable of transmitting light is provided. Net-like material 2 is formed by laminating two sheets of uniaxially stretched split fiber film 21 such that the stretching directions thereof are orthogonal to each other. Particles are added to the base resin of uniaxially stretched split fiber film 21. The particles are added to the resin in a range of 0.5 to 3 parts by mass per 100 parts by mass of the resin such that the average particle diameter of the particles is not less than 0.8 μm and the proportion of particles having a particle diameter that is not less than 0.4 μm is not less than 90%.

### TECHNICAL FIELD

The present invention relates to a net-like material having a heat shielding property and a light transmitting property.

### BACKGROUND ART

It is known that the cultivation of farm crops is significantly affected by the environment such as light, temperature, humidity and ventilation. So far, there have been developed so called light shielding and heat shielding materials which restrict the transmission of light and heat and thereby greatly contribute to the cultivation of farm crops.

For example, Japanese Patent Laid-Open No. 333978/99 discloses a light transmitting and heat shielding sheet in which aluminum is vapor-deposited on a substrate consisting of polyester film. Japanese Patent No. 2619313 discloses a covering material for heat shielding in which the surface of non-woven fabric is successively laminated with an aluminum layer or black mica layer and a titanium dioxide layer. The non-woven fabric is formed by laminating and bonding split fiber webs consisting of thermoplastic synthetic resin having a hydroxyl group so as to be crossed longitudinally and laterally. Each layer to be laminated onto the non-woven fabric is formed in such a way that the non-woven fabric is soaked into a hydrophilic synthetic resin liquid containing aluminum powder or black mica powder, thereafter heated and dried, then soaked into a hydrophilic synthetic resin liquid containing titanium dioxide powder, and heated and dried. Japanese Patent No. 3268738 discloses a heat shielding sheet consisting of a plastic sheet which partially or wholly includes a heat shielding area containing rainbow color pearl pigment obtained by coating the surface of mica with titanium dioxide in a thin film shape. Japanese Patent No. 3069776 discloses a light shielding material which is formed by coating at least one side of the non-woven fabric with a synthetic resin binder in which white pigment having a high refractivity is dispersed.

### DISCLOSURE OF THE INVENTION

However, since a sheet on which aluminum is deposited, or a sheet having aluminum powder or black mica powder shields heat by shielding light, it is not suitable for uses that require light. On the other hand, a sheet having titanium dioxide powder and a sheet having pigment have a higher light transmitting property compared with the above described sheets, but they are likely to have an insufficient heat shielding property. In order to obtain a sufficient heat shielding property, the amount of titanium dioxide powder or the pigment may be increased. However, when the amount of titanium dioxide powder or the pigment is increased, the transmission of light will be reduced. When pigment is coated, a problem may arise in that the pigment is likely to come off.

In particular, when a heat shielding sheet is used in a greenhouse in cultivating farm crops, light is necessary for the farm crops being cultivated even in a period when heat shielding is necessary. Further, if the inside of the greenhouse becomes dark, it is difficult to conduct work there. Therefore, such a sheet needs to have a light (visible light) transmitting property while having a heat shielding property as well.

The present invention has been made in view of the above described circumstances, and its object is to provide a net-like material which has an excellent heat shielding property while capable of transmitting light.

The present inventors has focused on the facts that a particle irradiated by light most effectively reflects light that has a wave length that is twice as large as the particle diameter thereof, and that the temperature rise caused by light radiation is significantly affected by infrared rays not by visible light. Then, the inventors have repeated investigations using variables of the average diameter and the diameter distribution of particles. As a result, they have found that by setting the particle diameter, the particle diameter distribution, and the amount of particles to be added to the base resin of the material, in an appropriate range, it is possible to achieve an excellent heat shielding effect while allowing light transmission, and thus have completed the invention.

That is, a net-like material of the present invention comprises base resin and particles that were added to the resin. There are added 0.5 to 3 parts by mass of the particles to 100 parts by mass of the resin such that the average diameter of the particles is not less than 0.8 μm, and the proportion of particles having a particle diameter of not less than 0.4 μm is not less than 90%.

By adding particles as described above, only infrared rays in the incident light are effectively shielded without degrading the transmission of visible light.

There is no specific limitation on the form of the net-like material according to the present invention. For example, it may be a sheet obtained by laminating a plurality of net-like films, which are obtained by stretching a film made of resin containing the above described particles in one direction and by forming it into a net-like form so that their stretching directions are orthogonal to each other, or it may be a sheet obtained by combining a plurality of tapes or yarns, which are made of resin containing the above described particles and which are formed by stretching in one direction, in such a way that their stretching directions are orthogonal to each other. Further, there is no limitation on the material of the particles to be added to the resin.

According to the net-like material of the present invention, it is possible to effectively reflect infrared rays without restricting the transmission of visible light. As a result, the net-like material of the present invention has an excellent light transmitting property as well as a heat shielding property. In particular, such a net-like material can be favorably used in agricultural applications where heat shielding is required while providing light to farm crops in a cultivating stage thereof.

### BRIEF DESCRIPTION OF THE DRAWINGS

FIG. 1 A plan view of a net-like material according to one embodiment of the present invention

FIG. 2A A partial perspective view of a uniaxially stretched split fiber film used in the net-like material shown in FIG. 1

FIG. 2B An enlarged perspective view to show a broken portion of the uniaxially stretched split fiber film shown in FIG. 2A

FIG. 3 A partial perspective view to show an original fabric film with slits provided therein, for use in the fabrication of the uniaxially stretched split fiber film shown in FIG. 2A

FIG. 4A A partial perspective view of a uniaxially stretched slit film applicable to the present invention

FIG. 4B An enlarged perspective view to show a broken portion of the uniaxially stretched slit film shown in FIG. 4A

FIG. 5 A plan view of a net-like material according to another embodiment of the present invention

FIG. 6 A perspective view of a net-like material according to a further embodiment of the present invention

### DESCRIPTION OF REFERENCE NUMERAL

2, 27, 29 Net-like material
21 Uniaxially stretched split fiber film
25 Uniaxially stretched slit film
28 Uniaxially stretched multi-layer tape

### BEST MODE FOR CARRYING OUT THE INVENTION

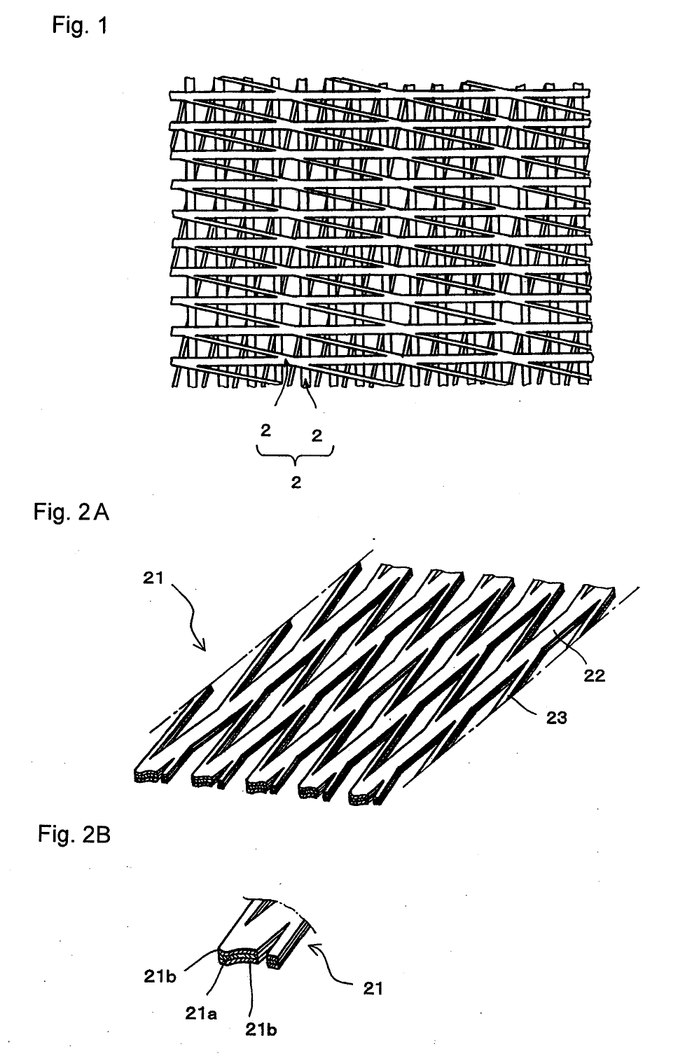

Referring to FIG. 1, there is shown net-like material 2 according to one embodiment of the present invention, which is formed by laminating two sheets of uniaxially stretched split fiber film 21 such that the stretching directions thereof are orthogonal to each other. Since uniaxially stretched split fiber film 21 is stretched in one direction and besides, has a net-like structure, it offers a high tensile strength in the stretching direction with small amount of material. Therefore, by laminating two sheets of uniaxially stretched split fiber film 21 such that the stretching directions thereof are orthogonal to each other, net-like material 2 has a good balance of strength in mutually orthogonal directions (for example, longitudinal and lateral directions).

Uniaxially stretched split fiber film 21 is made of resin to which particles are added. The particles to be added to the resin preferably have an average particle diameter of not less than 0.8 μm, more preferably not less than 0.9 μm, and the proportion of particles having a diameter of not less than 0.4 μm is not less than 90%.

When light is irradiated to a particle, light having a specific wavelength in the irradiated light will be reflected and/or dispersed, depending on the particle diameter. The light which is most likely to be reflected and/or dispersed is light having a wavelength that is twice the particle diameter. Since infrared rays have a wavelength of not less than 0.8 μm, it is possible to make net-like material 2 especially effective for reflecting and/or dispersing infrared rays from the incident light by fabricating net-like material 2 using a base resin into which an increased proportion of particles having a particle diameter not less than 0.4 μm is added.

The amount of particles that are added to the base resin of net-like material 2 is 0.5 to 3 parts by mass, preferably 0.7 to 3 parts by mass, per 100 parts by mass of the resin. When the amount of added particles is less than 0.5 parts by mass, although the light transmitting property will be improved, it is unlikely that a sufficient heat shielding property will be obtained. On the other hand, when the amount of added particles is more than 3 parts by mass, although the heat shielding property will be improved, the light transmitting property will be degraded.

By utilizing the resin into which particles are added as describe above, it becomes possible to effectively reflect infrared rays without restricting the transmission of visible light, consequently achieving net-like material 2 that has excellent light transmitting and heat shielding properties. There is no limitation on the material of the particle to be added. Naturally, it also has good air permeability since it has a net-like form.

Conventional heat shielding materials shield heat by shielding light. In contrast, net-like material 2 according to the present invention shields heat while transmitting light, which is a function not available in the related art. Such net-like material 2 is particularly preferable for use in agricultural applications. When net-like material 2 is used in an agricultural application, by using it in the period requiring heat shielding during the stage when crops are cultivated, it becomes possible to efficiently cultivate crops since it can shield heat while supplying necessary light to the crops. Highland vegetables have been cultivated in high altitude regions since they are vulnerable to high temperatures. Therefore, by using net-like material 2, it will become possible to cultivate them at lower altitude regions. Further, even if net-like material 2 is provided as a cover around a greenhouse, since it will not darken the environment because of its high light transmission rate, work inside the greenhouse will not be hindered.

Now, uniaxially stretched split fiber film 21 will be described.

As shown in FIG. 2B, uniaxially stretched split fiber film 21 has a layer configuration in which each surface of layer 21a made of a first thermoplastic resin is laminated with layer 21b made of a second thermoplastic resin which has a lower melting point than that of the first thermoplastic resin. As shown in FIG. 2A, uniaxially stretched split fiber film 21 is formed of a plurality of trunk fibers 23 extending parallel to each other, and branch fibers 24 which extend and cross trunk fibers 23 and connecting adjacent trunk fibers 23. At least one of layers 21a, 21b or both layers 21a, 21b contain particles as described above. Branch fiber 24 is thinner compared with trunk fiber 23, and the mechanical strength of uniaxially stretched split fiber film 21 is primarily provided by trunk fibers 23.

The thickness of layer 21b made of the second thermoplastic resin is not more than 50%, preferably not more than 40% of the whole thickness of uniaxially stretched split fiber film 21. In order to satisfy requirements for various material properties for uniaxially stretched split fiber film 21, such as bonding strength during thermo-compression boding, the thickness of layer 21b made of the second thermoplastic resin may be not less than 5 μm, but preferably it is selected from a range of 10 to 100 μm.

Examples of the manufacturing method of uniaxially stretched split fiber film 21 include followings.

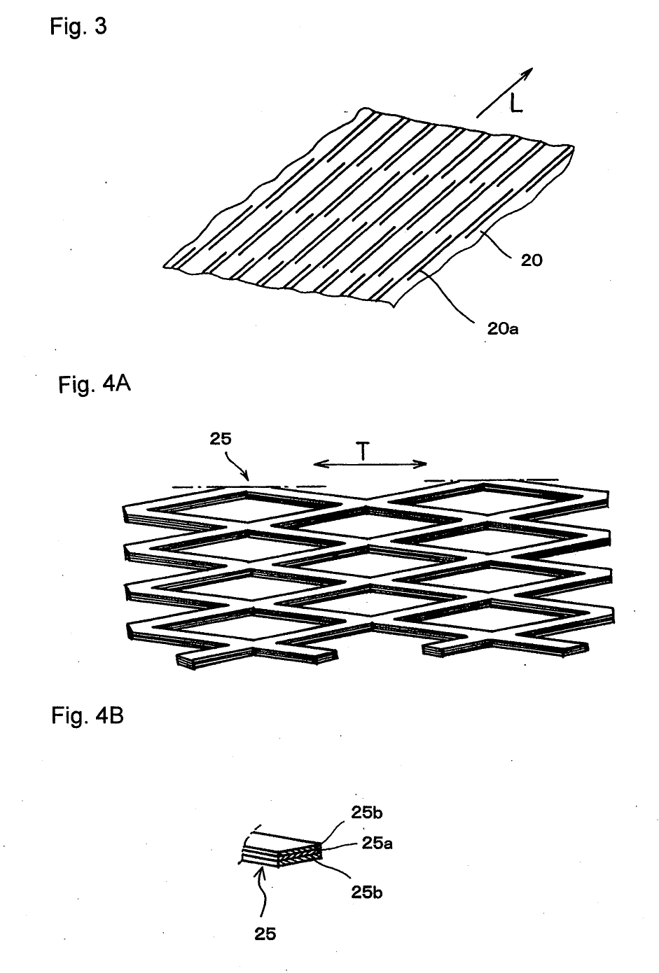

First, by an extrusion molding method such as a multilayer inflation method or a multilayer T-die method, a original fabric film having a three-layer structure is prepared in which layers 21b made of a second thermoplastic resin are laminated on each surface of layer 21a made of a first thermoplastic resin. Then, the original fabric film is stretched in the longitudinal direction (L direction in FIG. 3), and a large number of parallel slits 20a are formed in a longitudinally staggered arrangement in original fabric film 20 as shown in FIG. 3. Slits 20a may be formed either by split processing, that is, splitting original fabric film 20 using a splitter, or by slit processing which is subjected to original fabric film 20 using a hot blade. Then, original fabric film 20 which has been provided with slits 20a, is widened in the direction orthogonal to the direction of slit 20a. Thus, there is obtained uniaxially stretched split fiber film 21 in which trunk fibers 23 are mostly aligned in the longitudinal direction as shown in FIG. 2A.

The stretching ratio (orientation ratio) is preferably 1.1 to 15, and more preferably 3 to 10. When the stretching ratio is less than 1.1, there is a risk that the mechanical strength will not be sufficient. On the other hand, when the stretching ratio is larger than 15, stretching by an ordinary method becomes difficult resulting in the problem that expensive equipment is needed, for example. It is preferable to perform stretching in multiple stages to prevent unevenness in stretching.

Two sheets of uniaxially stretched split fiber film 21 fabricated, as so far described, are superposed such that trunk fibers 23 thereof are orthogonal to each other, and heated and fusion-bonded to obtain net-like material 2 as shown in FIG. 1. The thermally fusion bonding is performed in such a way that two superposed sheets of uniaxially stretched split fiber film 21 are fed between a pair of heating cylinders, which are opposedly disposed, to be fusion-bonded while being fixed so as not to produce shrinkage in the width direction. Further, the thermally fusion bonding is performed at a temperature that is not higher than the melting point of the first thermoplastic resin and that is not lower than the melting point of the second thermoplastic resin so that the stretching effect of layer 21a made of the first thermoplastic resin will not be lost.

In order to arrange two sheets of uniaxially stretched split fiber film 21 so that their trunk fibers 23 are orthogonal to each other, it is necessary that one of the two sheets of uniaxially stretched split fiber film 21 is fed as it is, and that the other is intermittently fed in the direction perpendicular thereto, after it is cut into tile-like pieces having the same width as that of net-like material 2 that is to be produced. For that reason, in net-like material 2 shown in FIG. 1, there would be seams between tile-like pieces of uniaxially stretched split fiber film 21 at even intervals.

Although, uniaxially stretched split fiber film 21 is taken as example for describing the raw material to be preferably used for net-like material 2, there is also a uniaxially stretched slit film which has a similar structure to that of uniaxially stretched split fiber film 21. This uniaxially stretched slit film may also be preferably used in the present invention. Hereafter, the uniaxially stretched slit film will be described.

FIG. 4A shows uniaxially stretched slit film 25 which is preferably used in the present invention. Uniaxially stretched slit film 25 can be fabricated from an original fabric film having the same structure as that of the original fabric film which is used for fabricating uniaxially stretched split fiber film 21 shown in FIG. 2A. That is, uniaxially stretched slit film 25 consists of layer 25a and layer 25b, layer 25a is made of a first thermoplastic resin, and layer 25b is made of a second thermoplastic resin which has a lower melting point than that of the first thermoplastic resin, and layer 25b is laminated on each surface of layer 25a. Then, the original fabric film is subjected to a splitting or slitting process in a staggered arrangement in the lateral direction (arrow T direction in FIG. 4A), and then stretched in the lateral direction thereby opening each slit longitudinally into an aperture. Thus, uniaxially stretched slit film 25 is obtained. Although seams will exist in the same way as described above, it is possible to obtain a net-like material having a good balance of strength in the lateral and longitudinal directions, by laminating uniaxially stretched slit films 25 shown in FIG. 4A such that the stretching directions thereof are orthogonal to each other.

When the presence of seams in the net-like material are not preferable, uniaxially stretched split fiber film 21 shown in FIG. 2A and uniaxially stretched slit film 25 shown in FIG. 4A may be laminated such that the longitudinal directions are aligned with each other. In this way, it becomes possible to continuously feed uniaxially stretched split fiber film 21 and uniaxially stretched slit film 25, as they are, and to make them thermally fusion bonded, thereby providing a seamless net-like material.

When forming a net-like material in which uniaxially stretched split fiber film 21 and uniaxially stretched slit film 25 are laminated, it is also possible to prefabricate uniaxially stretched split fiber film 21 and uniaxially stretched slit film 25, and laminate them while rolling each of them out from a rolled state. Alternatively, it is also possible to prefabricate either uniaxially stretched split fiber film 21 or uniaxially stretched slit film 25 and to laminate two films by supplying the prefabricated film to the line that manufactures the other film. According to the latter method, it is possible to simplify the manufacturing process of the net-like material and thereby provide the net-like material at a lower cost.

There has been shown, in the above described examples, a case in which two sheets of film are laminated to provide high mechanical strength both in the longitudinal and lateral directions. However, since uniaxially stretched split fiber film 21 and uniaxially stretched slit film 25 themselves have a net-like structure, it is possible to form a net-like material from only one sheet of uniaxially stretched split fiber film 21 or from one sheet of uniaxially stretched slit film 25, in an application in which a high mechanical strength is needed in only one direction. Further, it is also possible to laminate three or more sheets of uniaxially stretched split fiber film 21 and/or uniaxially stretched slit film 25 as needed.

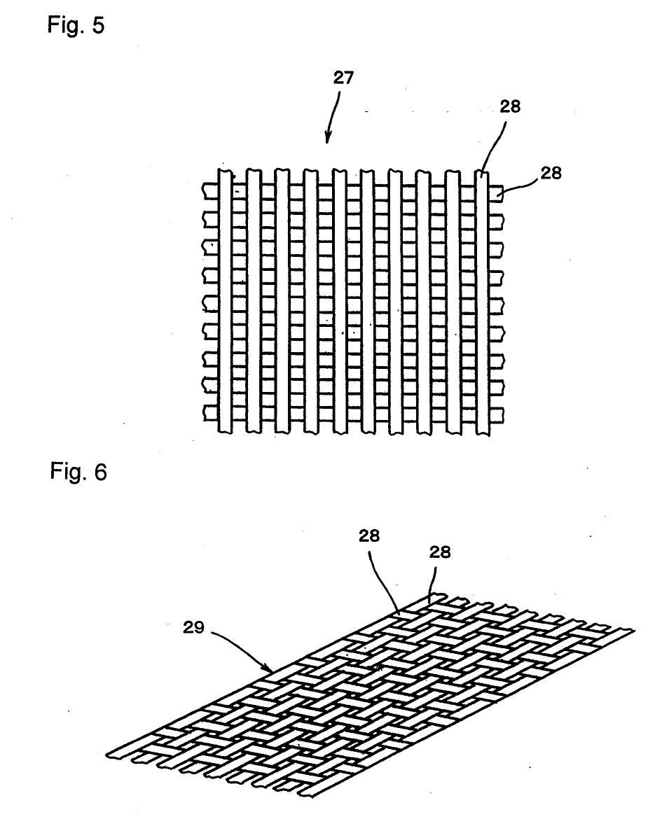

Moreover, although the film itself has a net-like structure in the above described examples, it is also possible to combine uniaxially stretched tapes made of a thermoplastic resin to form a net-like structure, or to combine stretched yarns which are spun from a thermoplastic resin to form a net-like structure. As an example of such, net-like materials 27 and 29 which include uniaxially stretched multi-layer tape 28 are shown in FIGS. 5 and 6. These net-like materials 27 and 29 are both comprised of the uniaxially stretched multi-layer tape which is formed by stretching an original fabric film, which is similar to that used in fabricating uniaxially stretched split fiber film 21 shown in FIG. 2A, by 1.1 to 15 times, preferably 3 to 10 times and thereafter cutting it into a 2 to 7 mm width along the stretching direction. The cutting of the original fabric film may be performed before stretching. Net-like material 27 shown in FIG. 5 is formed by arranging a plurality of uniaxially stretched multi-layer tapes 28 in parallel to each other at even intervals, and laminating the arrangement into two layers such that the longitudinal directions of uniaxially stretched multi-layer tape 28 are orthogonal to each other. Net-like material 29 shown in FIG. 6 is formed by weaving the above described uniaxially stretched multi-layer tape 28 into warp and weft.

So far, the present invention have been described with reference to preferred embodiments by way of example; in the net-like material of the present invention, its structure and the shape of apertures may be arbitrarily chosen, provided that it contains the above described fine particles of a predetermined particle diameter and a predetermined proportion in the base resin and provided that it is fabricated into a net-like form. Moreover, there is no specific limitation on the base resin. Examples of the base resin of the net-like material of the present invention include one kind of, or combinations of two or more kinds of polyester resin, polyamide resin, polypropylene resin, polyethylene resin and others. Further, it is also possible to add, in addition to the above described fine particles, additives such as antioxidants, weather-proof agents, lubricants, anti-blocking agents, flame-retardants, nucleating agents, and anti-static agents as needed.

The net-like material of the present invention may be used for various applications besides agricultural applications, such as packaging materials for fruits and vegetables, heat shielding materials for automobiles, outdoor materials such as tents and sheets.

Next, specific examples of the present invention will be described together with comparative examples.

First, titanium oxide was used as the particle to be added to the base resin. The average particle diameter and the proportion of particles which have a particle diameter of not less than 0.4 μm of titanium oxide were prepared as shown by particle A-1, particle A-2, and comparative particles 1 to 4 in Table 1.

TABLE 1

| | | Proportion (%) of particles |
|---|---|---|
| | Average particle | having a diameter not less |
| | diameter (μm) | than 0.4 μm |
| Particle A-1 | 1.07 | 97 |
| Particle A-2 | 0.82 | 91 |
| Comparative particle 1 | 0.62 | 83 |
| Comparative particle 2 | 0.77 | 88 |
| Comparative particle 3 | 0.60 | 91 |
| Comparative particle 4 | 0.81 | 79 |

Polyethylene was used as the base resin and a predetermined amount (represented by percent by mass with respect to base resin) of the above described particles were added to the polyethylene to form net-like materials designated as examples 1 to 4 and comparative examples 1 to 8 (see Table 2). The net-like materials were formed by laminating two layers of uniaxially stretched split fiber film 21 into warp and weft as with the one shown in FIG. 1, with their detailed specifications conforming to grade EX24 of WARIFU (registered trade mark), which is a split fiber non-woven fabric supplied by NISSEKI PLASTO Co., Ltd.

The above described examples 1 to 4 and comparative examples 1 to 8 were subjected to evaluation of heat shielding property and light transmitting property respectively. The evaluation of heat shielding property and light transmitting property respectively was performed as follows.

### <Heat Shielding Property>

Semi-cylindrical tunnels having a radius of about 40 cm were set up in the outdoors using net-like materials obtained by examples 1 to 4 and the comparative examples 1 to 8, and the ground surface temperatures outside and inside the tunnel were measured to obtain the temperature difference therebetween during the daytime of a fine day in midsummer (between late July and late August in the case of Kanto area) after the end of the rainy season. When a tunnel is set up by using net-like material, the heat shielding property is supposed to become higher as the temperature inside the tunnel becomes lower thereby increasing the difference between the temperature inside and outside the tunnel.

### <Light Transmitting Property>

An illumination apparatus COLD LIGHT SOURCE HL150 (product number) supplied by HOYA-SCHOTT Co., Ltd. was used to measure illuminance for cases where the net-like material is inserted between the light source and the illuminance meter and not inserted between the light source and the illuminance meter. The light transmitting property is represented by the ratio of the illuminance in cases where the net-like material is inserted to the illuminance in cases where the net-like material is not inserted. As the ratio becomes larger, i.e. as the illuminance difference due to the presence or absence of the net-like material becomes smaller, the light transmitting property is supposed to become higher. A white halogen lamp having an illuminance of 2000 Lx was used as the light source of the illumination apparatus.

The kind, the amount of particles that are added, and the evaluation results of added particles for examples 1 to 4 and comparative examples 1 to 8 are shown in Table 2.

TABLE 2

| | | Amount of | | |
|---|---|---|---|---|
| | | added | Heat | Light |
| | Added | particles | shielding | transmitting |
| | particle | (% by mass) | property (° C.) | property (%) |
| Example 1 | Particle | 0.6 | 6 | 89 |
| | A-1 | | | |
| Example 2 | Particle | 1.2 | 11 | 85 |
| | A-1 | | | |
| Example 3 | Particle | 3.0 | 13 | 76 |
| | A-1 | | | |
| Example 4 | Particle | 1.2 | 7 | 80 |
| | A-2 | | | |
| Comparative | Particle | 0.4 | 2 | 91 |
| example 1 | A-1 | | | |
| Comparative | Particle | 3.4 | 14 | 74 |
| example 2 | A-1 | | | |
| Comparative | Comparative | 1.0 | 3 | 72 |
| example 3 | particle 1 | | | |
| Comparative | Comparative | 3.0 | 8 | 59 |
| example 4 | particle 1 | | | |
| Comparative | Comparative | 1.2 | 3 | 71 |
| example 5 | particle 1 | | | |
| Comparative | Comparative | 1.2 | 4 | 74 |
| example 6 | particle 2 | | | |
| Comparative | Comparative | 1.2 | 2 | 77 |
| example 7 | particle 3 | | | |
| Comparative | Comparative | 1.2 | 5 | 67 |
| example 8 | particle 4 | | | |

The results shown in Table 2 indicate that each of examples 0.1 to 4 exhibited a heat shielding property of not less than 5° C. and a light transmitting property of not less than 75%, and thus it can be concluded that they are superior in both heat shielding property and light transmitting property.

On the other hand, although comparative example 1 utilized the same added particles as those used for examples 1 to 3, it exhibited a poor heat shielding property since the amount of particles that were added was too small. Comparative example 2 exhibited a poor light transmitting property since the amount of particles that were added was too large, contrary to comparative example 1. Since, in comparative examples 3 to 5, the particle diameter of the added particles was too small and the proportion of particles having a particle diameter that was not less than 0.4 μm was also too small, at least the heat shielding property or the light transmitting property or both the heat shielding and light transmitting properties were inferior even when the amount of particles that were added was varied. Although comparative example 6 had a larger particle diameter compared with comparative example 5, and a larger proportion of particles having a particle diameter that was not less than 0.4 μm, the heat shielding property and the light transmitting property were still insufficient. Comparative example 7, in which the particle diameter of the added particles was too small, exhibited a poor heat shielding property. Comparative example 8, in which the proportion of particles having a particle diameter that was not less than 0.4 μm was too small, exhibited a poor light transmitting property. Further, comparing the cases where the amount of particles that were added was 1.2% by mass with each other, it was concluded that comparative examples 5 to 8 were inferior compared with examples 2 and 4 in both the heat shielding property and the light transmitting property.

1. A net-like material, comprising:
a base resin; and
particles added to said resin, wherein said particles are added to said resin in a range of 0.5 to 3 parts by mass per 100 parts by mass of said resin such that an average diameter of said particles is not less than 0.8 μm and a proportion of particles having a particle diameter that is not less than 0.4 μm is not less than 90%.

2. The net-like material according to claim 1, wherein said net-like material is formed by laminating a plurality of uniaxially stretched net-like films made of resin to which said particles are added such that stretching directions thereof are orthogonal to each other.

3. The net-like material according to claim 1, wherein said net-like material is formed by combining a plurality of uniaxially stretched tapes or yarns made of resin to which said particles are added such that stretching directions thereof are orthogonal to each other.

4. A net-like material for cultivating farm crops, which is formed in film, tape, or yarn, and comprises a base resin and micro-particles mixed therein, said micro-particles being contained in an amount of 0.5 to 3 parts by mass per 100 parts by mass of said resin and having an average diameter of not less than 0.8 μm, wherein no less than 90% by mass of the particles have particle diameters not less than 0.4 μm.

5. The net-like material according to claim 4, which comprises a plurality of films each having slits so as to be expandable by opening the slits, wherein the plurality of films are stacked in which expandable directions of the films are alternated by about 90°.

6. The net-like material according to claim 5, wherein each film is composed of multiple layers having different melting points, and at least one of the multiple layers contains the particles.

7. The net-like material according to claim 4, which comprises a plurality of tapes or yarns arranged in a layer, wherein the plurality of tapes or layers are stacked in which longitudinal directions of the tapes or yarns are alternated by about 90°.

8. The net-like material according to claim 7, wherein each layer is composed of multiple layers having different melting points, and at least one of the multiple layers contains the particles.

9. The net-like material according to claim 4, wherein the resin is a polyester resin, a polyamide resin, a polypropylene resin, a polyethylene resin, or a combination of the foregoing.

10. The net-like material according to claim 4, wherein the particles are titanium oxide.
